(19) United States
(12) Patent Application Publication
(10) Pub. No.: US 2007/0076618 A1
(43) Pub. Date: Apr. 5, 2007

(54) IP communication device and IP communication system therefor

(75) Inventor: Ryota Hirose, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 11/521,422

(22) Filed: Sep. 14, 2006

(30) Foreign Application Priority Data
Sep. 16, 2005 (JP) 2005-270626

(51) Int. Cl. H04L 12/26

(52) U.S. Cl. 370/249

(57) ABSTRACT

A pair of IP communication devices (called a source device and a destination device) perform communication using IP packets (e.g., MAC frames or jumbo frames) over a communication path lying therebetween. The IP communication device checks whether or not the size of an MAC frame exceeds the maximum frame size that is determined in advance; then, an ICMP error is sent back to the source device having an IP address, which is included in a prescribed part of the MAC frame. The source device also executes path MTU discovery so as to determine an appropriate MTU, thus improving the communication efficiency without causing a black hole in communication.

### BACKGROUND OF THE INVENTION

1. Field of the Invention

The present invention relates to IP communication devices for performing communications using IP packets and to IP communication systems therefor.

This application claims priority on Japanese Patent Application No. 2005-270626, the content of which is incorporated herein by reference.

2. Description of the Related Art

The document entitled “RFC 791”, which can be retrieved online by way of the Internet using the URL of http://www.ietf.org/rfc/rfc791.txt, teaches that in the Internet protocol (IP) arranged for the Layer 3 (i.e., a network layer), the concept of MTU (i.e., Maximum Transmission Unit) is introduced to realize storage of information and data in accordance with a variety of protocols such as the Ethernet (i.e., the registered trademark) arranged for the Layer 2 (i.e., a data link layer). The MTU indicates the maximum data length that can be stored by way of protocols arranged for the Layer 2.

The maximum data length of an IP packet (or an IP datagram) is defined in 65535 octets. In order to store an IP packet by way of MAC frames, it should be divided into units of 1500 octets, each of which corresponds to the maximum frame size (i.e., MTU) of the Ethernet, for example.

Various protocols other than the Ethernet are arranged for the Layer 2; hence, various MTUs exist, so that IP packets may be stored in accordance with plural Layer-2 protocols in the Internet environments. When IP packets are transferred from a certain Layer-2 protocol having a relatively large MTU to another Layer-2 protocol having a relatively small MTU, it may be necessary to divide IP packets into plural fragments. When fragments occur, the total number of IP packets should be correspondingly increased so as to increase the total amount of transferred data because each IP packet is accompanied with a header; and this reduces the total communication efficiency. For this reason, node-to-node communications (or host-to-host communications) are used, wherein IP packets are divided by means of one of two nodes and another node (which exists in the path between the two nodes), which has the smallest MTU, thus increasing the communication efficiency. Initially, routers perform packet dividing; recently, transmission-source hosts perform packet dividing in order to reduce excessive loads of routers. In order to realize such procedures, a path MTU discovery method is introduced to discover the shortest MTU in communication paths; and this is taught in the document entitled “RFC 1191”, which can be retrieved online by way of the Internet using the URL of http:/www.ietf.org/rfc/rfc1191.txt.

FIG. 1 shows a path MTU discovery algorithm, which is realized by the following steps.
(1) First, a source host (Hi) sets up the Don't Fragment Flag in an IP header.
(2) An IP packet is subjected to transmission. In the case of FIG. 1, the transmitted IP packet has a packet length of 1500.
(3) When the IP packet whose data length exceeds the MTU is subjected to transmission, a router does not fragment the IP packet transmitted thereto but discards it.
(4) In the destination-unreachable situation, an error is notified to the source host in accordance with the ICMP (Internet Control Message Protocol). In the case of FIG. 1, a telephone line is laid between routers R1 and R2, for example, wherein MTU=576 (octets). For this reason, the router R1 discards the IP packet whose packet length is 1500 octets and which is transmitted thereto from the source host H1; then, it notifies an ICMP message with Type=3 (Destination Unreachable) and Code=4 (fragmentation needed and DF set), or an ICMP error, to the source host H1. The ICMP error includes information indicating that a path extending from the router R1 is set at MTU=576 (octets).
(5) Thereafter, packets each matching the notified MTU are subjected to retransmission. In this case, the source host H1 changes the MTU thereof to 576 octets, so that it retransmits an IP packet whose packet length is 576 octets to a destination host H2. Since a path lying between the source host H1 and the destination host H2 has a MTU that is 576 or more octets, the retransmitted IP packet completely reaches the destination host H2.

In the aforementioned example, the path MTU discovery process is ended upon reception of a single ICMP error. In general, however, the aforementioned steps (2) to (5) are repeated until the IP packet completely reaches the destination host H2 (in other words, until the notification of an ICMP no longer occurs).

FIG. 2 shows dividing and restructuring processes of IP packets transmitted between the source host H1 and the destination host H2 after completion of the aforementioned path MTU discovery process. As described above, the minimum MTU of 576 octets is set to the path lying between the source host H1 and the destination host H2. The source host H1 divides an IP packet whose packet length is 1500 octets into three packets, i.e., two packets each of which has a packet length of 576 octets and one packet whose packet length is 348 octets; hence, the source host H1 performs packet transmission three times toward the destination host H2. The destination host H2 restructures (or restores) the three packets into the original IP packet.

In order to increase the communication efficiency, MAC frames (called “jumbo frames”) whose maximum frame sizes exceed 1500 octets (which is defined by the prescribed standard) have been used in the Ethernet.

Jumbo frames have maximum frame sizes that are larger than the original MTU (i.e., 1500 octets) of the Ethernet; in other words, they may expand the original MTU of the Ethernet. No standard exists to clearly describe maximum frame sizes of jumbo frames; practically, MTUs depend upon manufacturers and products.

Because of the aforementioned reasons, network managers must check MTUs of devices, which are mutually linked together so as to perform communications using various frame sizes; hence, they must manually set up mutually linked devices so as to realize minimum MTUs being used in communication paths. Such manual setup operations are troublesome, and they may cause setup errors to down communications.

For example, when a reception-side device receives frames whose sizes are larger than a prescribed frame size defined by itself, it simply discards those frames in the Layer 2 (i.e., a data link layer). This may cause “a black hole” in which a transmission-side device cannot receive a reply regarding the transmission of the frames. The document entitled “RFC 2923”, which can be retrieved by way of the Internet using the URL of http://www.ietf.org/rfc/rfc2923.txt, teaches the method in which upon the occurrence of a black hole, the aforementioned path MTU discovery algorithm is used so as to retransmit MAC frames having reduced MTUs.

In the procedures of the path MTU discovery upon the occurrence of a black hole, the transmission-side device starts the path MTU discovery process after it waits for a time-out for detecting no reply from the reception-side device; hence, it takes a relatively long time before the start-up of the path MTU discovery process in comparison with the normal procedures.

In the normal procedures of the path MTU discovery, a node (or a reception-side device) sending an ICMP error describes information regarding a reference MTU in the ICMP error; hence, this makes it possible for a transmission-side device to check the MTU in the communication path based on the information. In the procedures of the path MTU discovery upon the occurrence of a black hole, no information is sent back to the transmission-side device; therefore, it may be necessary for the transmission-side device to use another method for fumbling the MTU to be reduced in a step-by-step manner, for example.

Suppose that, as shown in FIG. 3, packets are transmitted from the source host Hi having MTU=9000 (octets) to the destination host H2 having MTU=7000 (octets). When the source host H1 transmits a packet whose frame size is 9000 octets to the destination host H2, a switching hub SH lying therebetween simply transfers the corresponding MAC frame whose frame size is 9000 octets to the destination host H2. However, the MAC frame is oversized in the destination host H2, so that the destination host H2 directly discards it.

In the above, the source host H1 does not receive a reply from the host H2 over a prescribed time period, so that the source host H1 divides the MAC frame of 9000 octets into two MAC frames each having a half MTU (i.e., 4500 octets), and then, it retransmits the divided MAC frames each having MTU=4500 (octets), which is smaller than the MTU=7000 (octets) of the destination host H2; hence, the destination host H2 can reliably receive and process them.

In the above, the communication efficiency must be degraded because communications are performed using packets each having MTU=4500 (octets) with respect to the destination host H2 that is capable of receiving packets each having MTU=7000 (octets). In this case, it is possible to attempt performing packet dividing several times by changing a reduction ratio applied to the original MAC packet, thus calculating an appropriate frame size. However, this increases the number of times for attempting to perform packet dividing and eventually reduces the communication efficiency.

### SUMMARY OF THE INVENTION

It is an object of the present invention to provide an IP communication device that can perform highly efficient communication using jumbo frames and that eliminates the necessity of performing setups by the network manager.

In a first aspect of the present invention, an IP communication device includes a transmitter, a receiver, and a frame size checker for checking whether or not a frame size of the received data exceeds a maximum frame size, which is determined in advance. The IC communication device also produces an ICMP error including information, which is extracted from the received data to represent a source address, and the maximum frame size as an MTU, so that the ICMP error is sent back to the source address by means of the transmitter. Herein, path MTU discovery is executed upon reception of the ICMP error.

In a second aspect of the present invention, an IP communication system is constituted by a plurality of IP communication devices, each of which includes a transmitter, a receiver, and a frame size checker for checking whether or not a frame size of received data exceeds a maximum frame size, which is determined in advance. In addition, the IP communication device also produces an ICMP error including information, which is extracted from the received data to represent a source address, and the maximum frame size as an MTU. Furthermore, at least one IP communication device executes path MTU discovery upon reception of the ICMP error.

As described above, when the frame size of the received data exceeds the maximum frame size, the IP communication device sends back an ICMP error to the source address designated by the information included in the received data, wherein the ICMP error also includes the maximum frame size as the MTU. Hence, a source device having the source address can detect a frame-size-over error in the Layer 2 (i.e., the data link layer) as an error regarding an IP packet reaching the network layer. In addition, the source device can also detect an appropriate MTU suiting the communication path lying between the source device and the destination device.

Upon the reception of an ICMP error, the path MTU discovery is executed so that the transmitting frame size is adjusted to match the MTU of the IP communication device sending back the ICMP error. This rapidly determines the appropriate MTU suiting the communication path without causing a black hole in communication; hence, it is possible to improve the communication efficiency.

### BRIEF DESCRIPTION OF THE DRAWINGS

These and other objects, aspects, and embodiments of the present invention will be described in more detail with reference to the following drawings, in which:

FIG. 1 is a sequence diagram for explaining a path MTU discovery process with respect to a communication line lying between two hosts via routers;

FIG. 2 is a sequence diagram for explaining fragmentation of packets in a communication line between two hosts via routers;

FIG. 3 is a sequence diagram for explaining packet dividing in which a reduction ratio applied to an original MAC packet is changed with respect to a communication line lying between two hosts via a switching hub;

FIG. 4 is a block diagram showing the constitution of an IP communication device in accordance with a preferred embodiment of the present invention;

FIG. 5 shows the relationship between an IP packet and a MAC frame;

FIG. 6 shows the configuration of an ICMP packet;

FIG. 7 is a flowchart showing the processing of an IP communication device receiving data whose frame sizes are checked in comparison with a maximum frame size;

FIG. 8A is a flowchart showing the processing of an IP communication device upon reception of an ICMP error; and

FIG. 8B is a flowchart showing the details of path MTU discovery performed by the IP communication device.

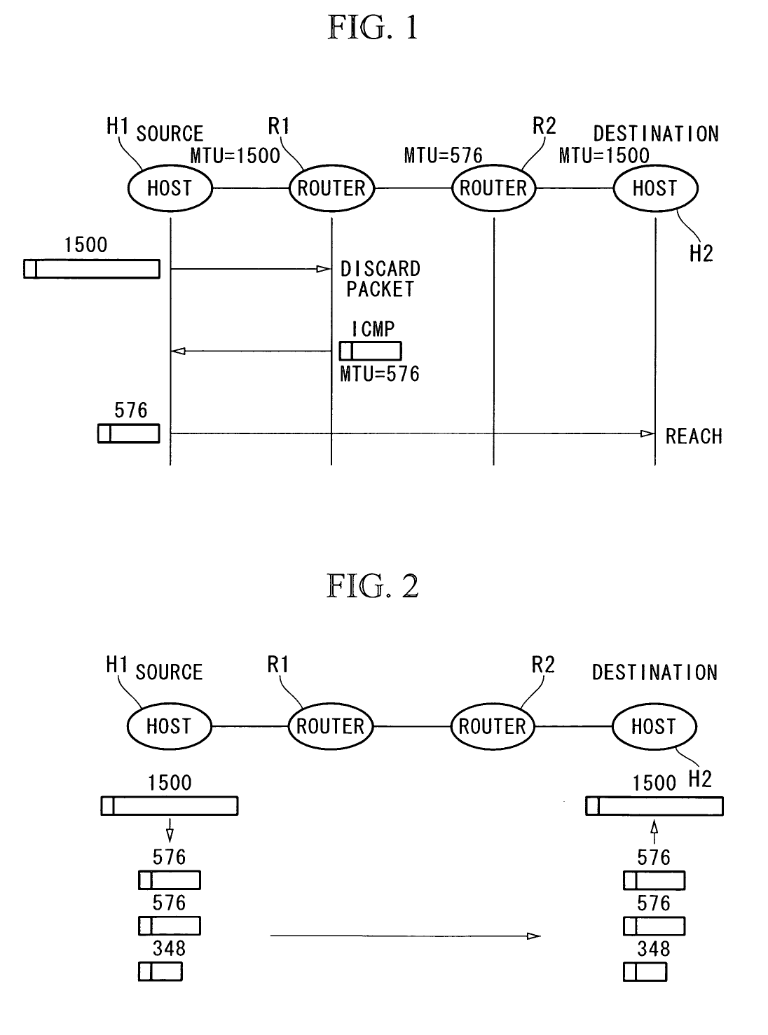

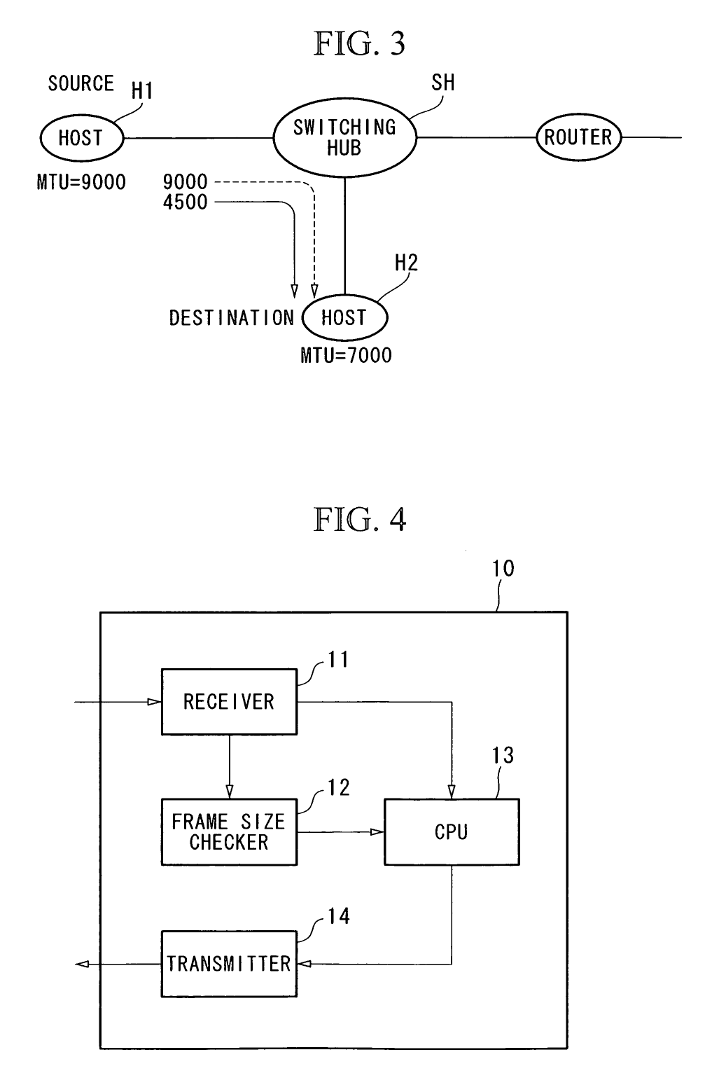

### DESCRIPTION OF THE PREFERRED EMBODIMENT

The present invention will be described in further detail by way of examples with reference to the accompanying drawings.

FIG. 4 is a block diagram showing the constitution of an IP communication device in accordance with a preferred embodiment of the present invention. A receiver 11 receives signals based on the Ethernet so as to perform buffering of MAC frames whose maximum frame sizes are each limited by a prescribed number of bits. A frame size checker 12 checks whether or not received MAC frames match the limited maximum frame size of buffering, in other words, it checks whether or not frame sizes of received MAC frames each exceed the limited maximum frame size of buffering. A CPU 13 analyzes the received and buffered MAC frames, which are subjected to prescribed processing. For example, in a Layer 2 (i.e., a data link layer), the CPU 13 extracts MAC headers, data portions, and FCS (frame check sequence) portions from the MAC frames so as to perform error checking. In a Layer 3 (i.e., a network layer), the CPU 13 extracts data portions from the MAC frames, i.e., IP headers and payloads (or data) of IP packets. In a Layer 4 (i.e., a transport layer), the CPU 13 extracts payloads of IP packets, i.e., TCP headers and data of TCP segments (where TCP stands for Transmission Control Protocol). With respect to a further high-order layer, the CPU 13 performs prescribed processing baaed on data of applications, which use the transmission control protocol (TCP) extracted from the TCP segment, for example.

In addition, the CPU 13 outputs MAC frames that should be transferred to a transmitter 14 via the Ethernet. The transmitter 14 transmits them via the Ethernet.

When the frame size checker 12 detects that the frame size of the received MAC frame exceeds the limited maximum frame size, the CPU 13 produces an ICMP error, which is then subjected to transmission by means of the transmitter 14.

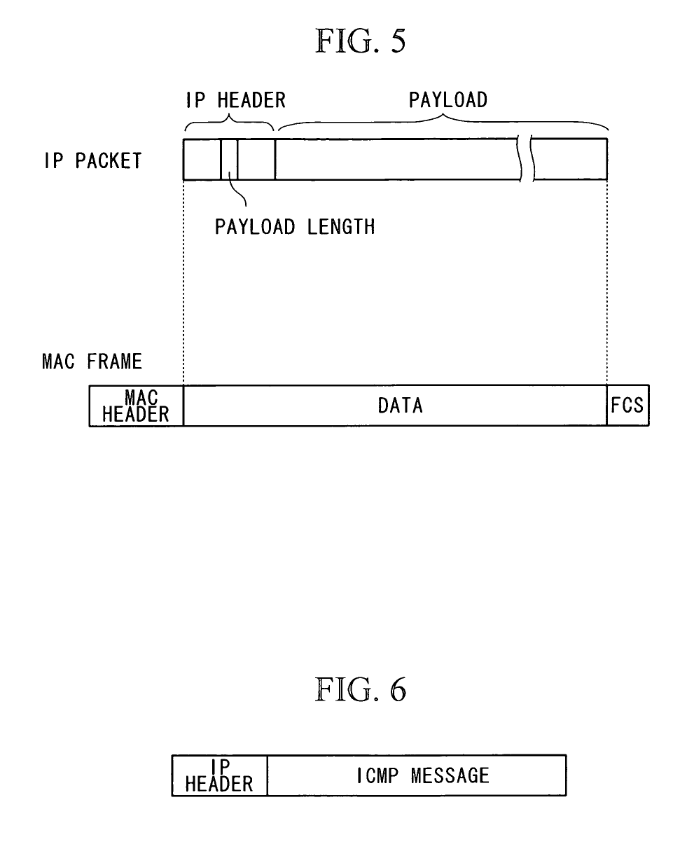

FIG. 5 shows the relationship between a MAC frame and an IP packet. The MAC frame includes a MAC header, data, and FCS. The MAC header includes a destination MAC address, a source MAC address, and a frame type. The IP packet includes an IP header and a payload. The IP header includes a source IP address, a destination IP address, and payload length.

FIG. 6 shows a packet corresponding to an ICMP error, which includes an IP header and an ICMP message. The ICMP message generally describes the information identifying the content (or cause) of an error and a first-half portion of the IP packet causing the error. However, in an ICMP error, which is produced when the frame size exceeds the limited maximum frame size so that the corresponding IP packet cannot be fully extracted, an ICMP message is produced by extracting a necessary portion of the IP packet from the data of the received MAC frame.

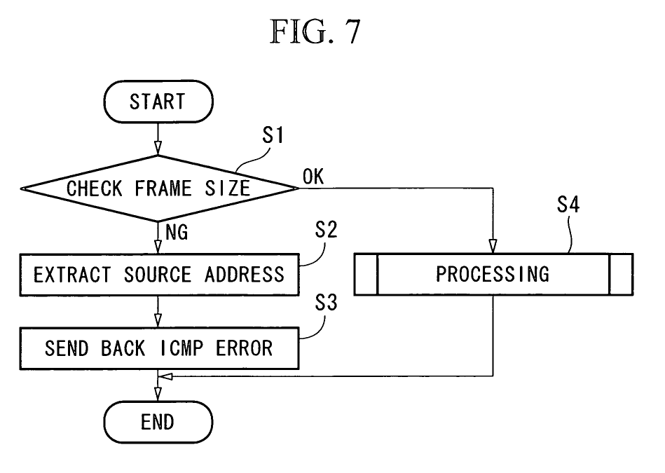

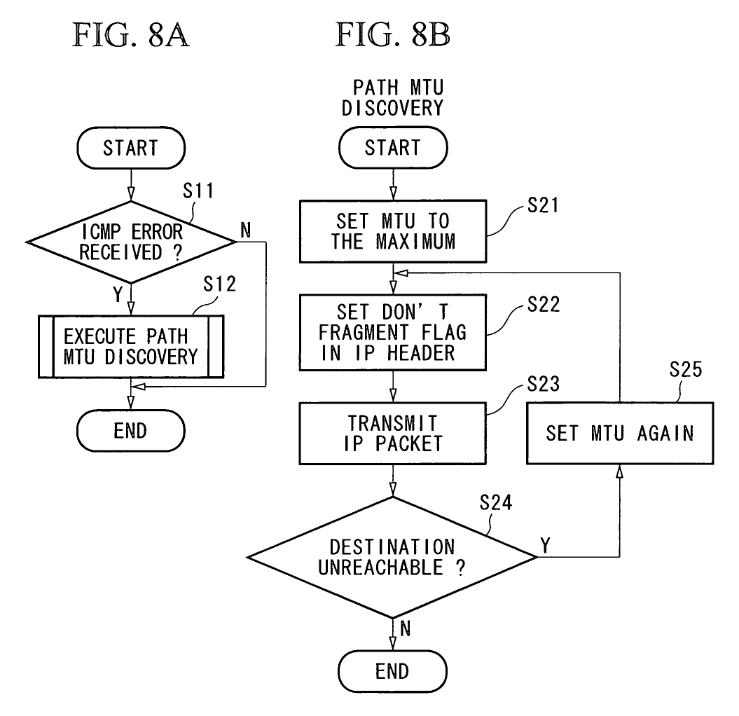

Next, the processing of the CPU 13 incorporated in the IP communication device shown in FIG. 4 will be described with reference to FIG. 7 and FIGS. 8A and 8B, wherein the IP communication device serves as a source device or a destination device in a communication path, or it serves as an intervening device lying between the source device and the destination device in the communication path.

FIG. 7 is a flowchart showing the processing of the CPU 13 of the IP communication device, which serves as the intervening device or the destination device in the communication path. When the frame size checker 12 shown in FIG. 4 produces a frame size checking result of “NG” indicating that the received frame size exceeds the “processible” maximum frame size, the CPU 13 extracts an IP address regarding the source device of the communication path from a first-half part of an MAC frame accumulated in the buffering of the receiver 11 so as to send back an ICMP error to the source device. This is realized by a series of steps S1, S2, and S3 shown in FIG. 7. The ICMP error is realized using the ICMP packet shown in FIG. 6 in which the IP header includes the extracted IP address of the source device and the IP address of the presently designated device, and the ICMP message includes “Type=3” (representing “Destination Unreachable”) and “Code=4” (representing a fragmentation error) in the case of IPv4 (i.e., Internet Protocol Version 4). In the case of IPv6 (i.e., Internet Protocol Version 6), the ICMP message includes a code of “Packet Too Big”. In addition, the ICMP message also includes an appropriate MTU representing a maximum frame size that is processible in the Layer 2 by the IP communication device.

When the frame size checker 12 produces a frame size checking result of “OK” indicating that the received frame size is not larger than the “processible” maximum frame size, the normal processing is performed on the corresponding MAC frame in step S4.

Next, the details of the processing of the CPU 13 of the IP communication device serving as a source device in a communication path will be described with reference to FIGS. 8A and 8B. As shown in FIG. 8A, when the IP communication device receives an ICMP error, it performs path MTU discovery (see steps S11 and S12). FIG. 8B shows the details of the path MTU discovery. In step S21, MTU is set to a maximum value applied to the IP communication device. In step S22, the Don't Fragment Flag included in an IP header is set to “1”. In step S23, the IP communication device transmits an IP packet toward the destination device in the communication path.

When the IP communication device serving as the intervening device or destination device in the communication path receives an MAC frame whose frame size exceeds the aforementioned MTU, it sends back an ICMP error representing a Destination-Unreachable message (see step S3 shown in FIG. 7) to the source device in the communication path; hence, the IP communication device serving as the source device receives such an ICMP error. In this case, the IP communication device reads the MTU included in the ICMP error so as to perform fragmentation on the corresponding IP packet, which is then fragmented and retransmitted to the destination device. This is realized by a series of steps S24, S25, S22, and S23.

The aforementioned steps are repeated until the IP communication device does not receive the aforementioned ICMP error representing the Destination-Unreachable message. Thus, it is possible to produce appropriate MTUs in the communication path lying between the source device and the destination device.

An IP communication system is constituted by a plurality of IP communication devices, which serve as a source device, an intervening device, and a destination device in a communication path; hence, each IP communication device is designed to cope with the processing of FIG. 7 (in which the received frame size is checked, and an ICMP error is sent back to the source device as necessary) and the processing of FIGS. 8A and 8B (in which path MTU discovery is executed upon reception of an ICMP error). Specifically, the processing of step S4 (which is executed when the received frame size is “OK” in step S1) includes the path MTU discovery upon reception of an ICMP error (see FIGS. 8A and 8B).

In FIGS. 8A and 8B, the reception of an ICMP error triggers the path MTU discovery to be executed; hence, the ICMP error is notified again to the source device during the processing of the path MTU discovery. Since the foregoing ICMP error, which is notified to the source device upon the reception of an MAC frame whose frame size exceeds the prescribed MTU, includes an appropriate MTU, the source device can change the MTU thereof with the appropriate MTU upon the first reception of the ICMP error, thus reducing the path MTU discovery.

As described heretofore, the present invention is not necessarily limited to the aforementioned embodiment, which is illustrative and not restrictive; hence, it is possible to provide further variations within the scope of the invention as defined in the appended claims.

What is claimed is:

1. An IP communication device comprising:
a transmitter for transmitting data via a network;
a receiver for receiving data via the network;
a frame size checker for checking whether or not a frame size of received data exceeds a maximum frame size, which is determined in advance; and
an ICMP error producing means for producing an ICMP error including information, which is extracted from the received data to represent a source address, and the maximum frame size as an MTU,
wherein the ICMP error is sent back to the source address by means of the transmitter.

2. An IP communication device according to claim 1 further comprising an execution means for executing a path MTU discovery upon reception of the ICMP error.

3. An IP communication system including a plurality of IP communication devices, each of which comprises a transmitter, a receiver, a frame size checker for checking whether or not a frame size of received data exceeds a maximum frame size, which is determined in advance, and an ICMP error producing means for producing an ICMP error including information, which is extracted from the received data to represent a source address, and the maximum frame size as an MTU.

4. An IP communication system according to claim 3, wherein at least one of the IP communication devices further includes an execution means for executing a path MTU discovery upon reception of the ICMP error.
